(19) United States
(12) Patent Application Publication
(10) Pub. No.: US 2017/0082912 A1
(43) Pub. Date: Mar. 23, 2017

(54) LIGHT SOURCE DEVICE AND PROJECTOR

(71) Applicant: NEC Display Solutions, Ltd., Tokyo (JP)

(72) Inventors: Osamu WAKABAYASHI, Tokyo (JP); Masateru MATSUBARA, Tokyo (JP)

(21) Appl. No.: 15/125,949

(22) PCT Filed: Mar. 31, 2014
(86) PCT No.: PCT/JP2014/059508

§ 371 Date: Sep. 13, 2016

(30) Foreign Application Priority Data
May 26, 2014 (CN) 20142027354.7
May 26, 2014 (CN) 201410226360.3

(51) Int. Cl. G03B 21/20; G03B 21/00; G02B 26/00; G02B 27/14; G02B 5/30

(52) U.S. Cl. CPC G03B 21/204; G02B 27/141; G02B 5/3083; G02B 26/008; G03B 21/2073; G03B 21/005

(57) ABSTRACT

Light source device includes a light source, a dichroic mirror that reflects the S-polarized light of light from light source, a condensing lens group that converges reflected light from the dichroic mirror, a phosphor unit movable so that light from a condensing lens group is sequentially radiated to a phosphor region and a reflection region, and a ¼ wavelength plate provided between the lenses of the condensing lens group.

### TECHNICAL FIELD

The present invention relates to a light source device that includes a phosphor, and a projector using the same.

### BACKGROUND ART

Patent Literature 1 describes the light source device of a projector that uses a phosphor as a light source. FIG. 1 illustrates the configuration of the light source device.

Referring to FIG. 1, excitation light source 116 includes a plurality of blue laser diodes (LD). Blue excitation light output from excitation light source 116 is converted into a parallel light flux by collimator lens array 106, and then enters dichroic mirror 115. Excitation light source 116 is disposed so that output light can enter dichroic mirror 115 as S-polarized light. Dichroic mirror 115 is disposed so that the incident angle of the blue excitation light can be 45°. Note that the incident angle is an angle formed between an incident light beam and a normal set at an incident point.

FIG. 2 illustrates the spectral transmission characteristics of dichroic mirror 115. A vertical axis indicates a transmittance, and a horizontal axis indicates a wavelength (nm). A solid line indicates spectral transmission characteristics with respect to S-polarized light, and a broken line indicates spectral transmission characteristics with respect to P-polarized light. The cutoff wavelength of the S-polarized light is 456 nm, and the cutoff wavelength of the P-polarized light is 434 nm Note that the cutoff wavelength is a wavelength having a transmittance of 50%.

Dichroic mirror 115 has the characteristics of transmitting light of 456 nm or more and reflecting light less than 456 nm for the S-polarized light, and has the characteristics of transmitting light of 434 nm or more and reflecting light less than 434 nmnm for the P-polarized light. The wavelength of the blue excitation light is, for example, 445 nm The blue excitation light (S-polarized light) from excitation light source 116 is reflected by dichroic mirror 115.

The blue excitation light (S-polarized light) reflected by dichroic mirror 115 passes through ¼ wavelength plate 108 to be converted into circular polarized light. The blue excitation light (circular polarized light) that passed through ¼ wavelength plate 108 is converged on phosphor layer 103 by two condensing lenses 109a and 109b.

Phosphor layer 103 is formed on a substrate on which dichroic coating is formed. The substrate is divided into first to third segments in a circumferential direction, and phosphor layer 103 includes a red phosphor region formed in the first segment, and a green phosphor region formed in the second segment. The third segment has been subjected to reflection coating. The first to third segments are sequentially irradiated with blue excitation light (circular polarized light) by rotating the substrate.

In the first segment, a phosphor excited by blue excitation light emits red fluorescent light. In the second segment, a phosphor excited by blue excitation light emits green fluorescent light. In the third segment, blue excitation light (circular polarized light) is reflected on a reflection coat surface.

The red fluorescent light from the first segment, the green fluorescent light from the second segment, and the blue light (circular polarized light) reflected on the reflection coat surface of the third segment sequentially pass through condensing lenses 109a and 109b and ¼ wavelength plate 108. Here, the blue light (circular polarized light) from the third segment is converted into P-polarized light after passing through ¼ wavelength plate 108. The red fluorescent light, the green fluorescent light, and the blue light (P-polarized light) are respectively transmitted through dichroic mirror 115.

Though not illustrated in FIG. 1, the red fluorescent light, the green fluorescent light, and the blue light (P-polarized light) that are transmitted through dichroic mirror 115 are converged on one end surface of a rod integrator by the condensing lens. In the rod integrator, the light made incident from one end surface propagates through the rod to exit from the other surface. The use of the rod integrator enables acquisition of the output light of a light intensity distribution uniform on a surface vertical to an optical axis.

Generally, when a LD is used for an excitation light source, a ¼ wavelength plate made of highly light-resistant crystal is used. However, while it serves to provide a phase difference of π/2 (=¼λ) for light having an incident angle of 5° or less, the ¼ wavelength crystal plate has angle dependence in which polarized light is maintained for light having an incident angle exceeding 5°. This necessitates the ¼ wavelength crystal plate to be disposed on an optical path close to a parallel light flux.

In the light source device illustrated in FIG. 1, similarly, since the LD is used for excitation light source 116, ¼ wavelength plate 108 is usually made of crystal. ¼ wavelength plate 108 is disposed between condensing lens 109a and dichroic mirror 115. However, as the blue excitation light between condensing lens 109a and dichroic mirror 115 is a parallel light flux, there is no influence of the angle dependence of ¼ wavelength plate 108.

### CITATION LIST

### Patent Literature

Patent Literature 1: JP2012-108486A

### DISCOVER OF INVENTION

However, a light source device described in Patent Literature 1 has the following problems.

Between phosphor layer 103 and the condensing lens of the rod integrator side, fluorescent light from phosphor layer 103 propagates as a divergent light flux. In this case, since the distance from phosphor layer 103 is longer, the light flux diameter of the fluorescent light is larger. Accordingly, when a distance from phosphor layer 103 to the condensing lens of the rod integrator side increases, the size of the condensing lens must be increased, thus causing an increase in size and cost of an optical system.

In addition, when the distance from phosphor layer 103 to the condensing lens of the rod integrator side increases, the distance between the condensing lens and the rod integrator increases, thus enlarging the optical system more.

For the aforementioned reason, it is desired that the distance from phosphor layer 103 to the condensing lens of the rod integrator side be as short as possible.

However, in the light source device described in Patent Literature 1, because ¼ wavelength plate 108 is disposed between condensing lens 109 and dichroic mirror 115, the distance between condensing lens 109 and dichroic mirror 115 increases and, as a result, the distance from phosphor layer 103 to the condensing lens of the rod integrator side increases. Thus, the problem of an increase in size and cost of the optical system occurs.

It is an object of the present invention to provide a light source device capable of achieving miniaturization and low cost of an optical system, and a projector that uses the same.

In order to achieve the object, according to an aspect of the present invention, there is provided a light source device including: a light source that emits excitation light; a dichroic mirror that is configured to reflect or transmit first linearly polarized light of light from the light source; a first condensing lens group that includes a plurality of lenses and that is configured to converge reflected light or transmitted light from the dichroic mirror; a phosphor unit that includes a phosphor region in which a phosphor is provided and a reflection region in which incident light is reflected and that is movable so that light from the first condensing lens group can be sequentially radiated to the phosphor region and the reflection region; and a ¼ wavelength plate that is provided between two adjacent lenses from among the plurality of lenses. Each of the first condensing lens group and the phosphor unit is disposed so that fluorescent light emitted from the phosphor region and reflected light from the reflection region enter the dichroic mirror via the first condensing lens group and the ¼ wavelength plate.

According to another aspect of the present invention, there is provided a projector including the aforementioned light source device, a display element that spatially modulates light output from the light source device to form an image, and a projection optical system that magnifies and projects the image formed by the display element.

### BRIEF DESCRIPTION OF DRAWINGS

FIG. 1 is a schematic diagram illustrating the configuration of a light source device described in Patent Literature 1.

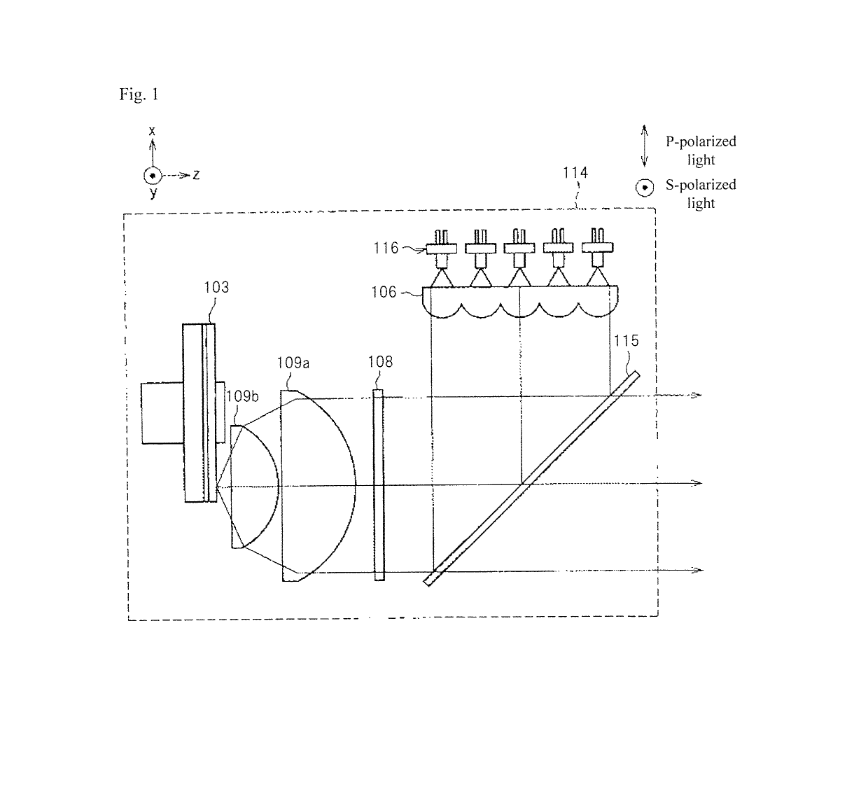

FIG. 2 is a characteristic diagram illustrating the spectral transmission characteristics of the dichroic mirror of the light source device illustrated in FIG. 1.

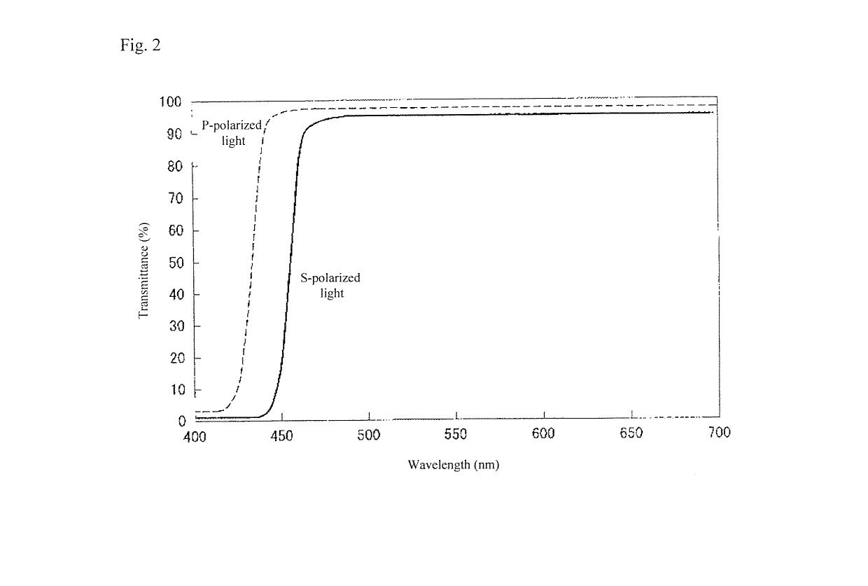

FIG. 3 is a schematic diagram illustrating the configuration of a light source device according to the first exemplary embodiment of the present invention.

FIG. 4 is a schematic diagram illustrating an example of a phosphor wheel used in the light source device illustrated in FIG. 3.

FIG. 5 is a schematic diagram illustrating an example of a color wheel used in the light source device illustrated in FIG. 3.

FIG. 6 is a schematic diagram illustrating a relationship between the disposing position of a ¼ wavelength plate and an incident region in the light source device illustrated in FIG. 3.

FIG. 7 is a diagram illustrating a beam angle distribution at each position illustrated in FIG. 6.

FIG. 8 is a schematic diagram illustrating the optical paths of blue light and fluorescent light in the light source device illustrated in FIG. 3.

FIG. 9 is a schematic diagram illustrating an example of a projector that includes the light source device illustrated in FIG. 3.

FIG. 10 is a schematic diagram illustrating an example of a projector that includes a light source device according to the third exemplary embodiment of the present invention.

### REFERENCE SIGNS LIST

1a Light source
1b Collimator lens
1c to 1e, 1i, 1k, 1m Lens
1f Polarized light separating element
1g Diffusion plate
1h Dichroic mirror
1j ¼ wavelength plate
1l Phosphor unit
1n Color filter unit

### DESCRIPTION OF EMBODIMENT

Next, the exemplary embodiments of the present invention will be described with reference to the drawings.

### First Exemplary Embodiment

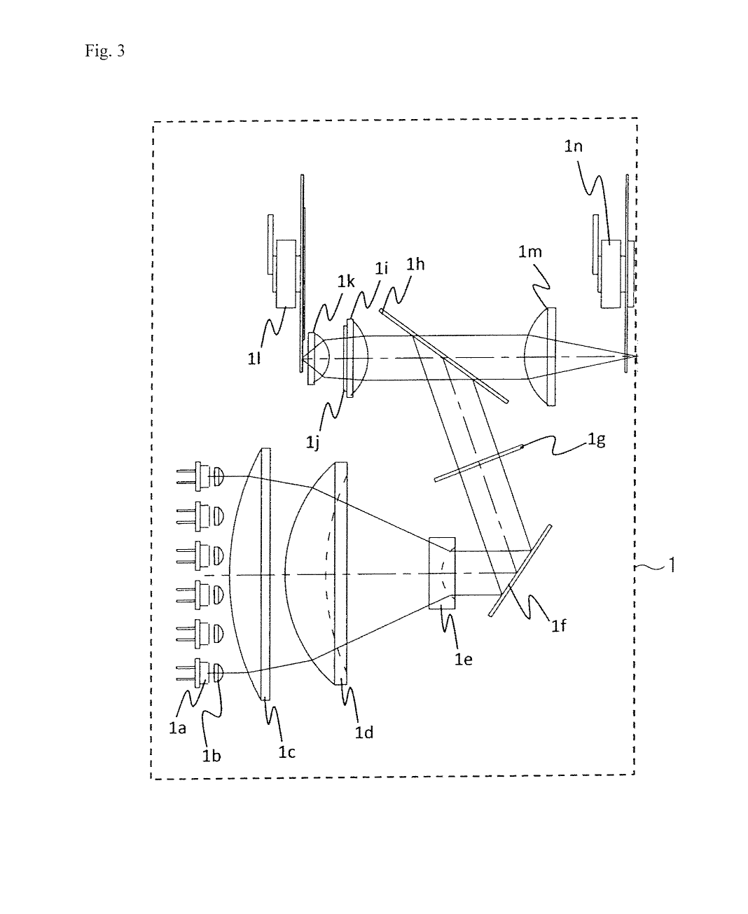

FIG. 3 illustrates the configuration of a light source device according to the first exemplary embodiment of the present invention.

Referring to FIG. 3, light source device 1 includes light source 1a, collimator lens 1b, lenses 1c to 1e, 1i, 1k, and 1m, polarized light separating element 1f, diffusion plate 1g, dichroic mirror 1h, ¼ wavelength plate 1j, phosphor unit 1l, and color filter unit 1n.

Light source 1a includes a blue laser diode (LD) for outputting blue light having a peak wavelength in a blue wavelength region. For example, light source 1a includes blue LDs arranged in the matrix of 6×4. However, the number of blue LDs is not limited to 24. The number of blue LDs may be increased/decreased as needed.

Collimator lens 1b is provided for each blue LD, and converts the blue light output from the blue LD into a parallel light flux.

Lenses 1c to 1e convert each blue light (incident light flux) made incident from light source 1a via collimator lens 1b into a parallel light flux in which the light flux diameter is reduced. By setting the diameter of the output light flux to be smaller than that of the incident light flux, the sizes of members arranged after lenses 1c to 1e can be reduced. Here, three lenses 1c to 1e are used. However, the number of lenses is not limited to three. The number of lenses may be increased/decreased as needed.

The blue light emitted from lenses 1c to 1e enters dichroic mirror 1h via polarized light separating element 1f. Diffusion plate 1g is disposed on an optical path between polarized light separating element 1f and dichroic mirror 1h. Diffusion plate 1g diffuses the blue light from polarized light separating element 1f. A diffusion angle is, for example, about 3°. Here, the diffusion angle is an angle formed between a light beam (central beam) passing through the center of a light flux and a light beam passing through the outermost side of the light flux.

Polarized light separating element 1f has the characteristics of separating S-polarized light and P-polarized light. Here, polarized light separating element 1f has the characteristics of reflecting the S-polarized light and transmitting the P-polarized light. Light source 1a is disposed so that its output light (blue light) can enter separating element 1f as S-polarized light. A polarization plate or a dichroic mirror can be used for polarized light separating element 1f.

The blue light (S-polarized light) reflected by polarized light separating element if enters dichroic mirror 1h. Dichroic mirror 1h has, with respect to light that is made incident as the S-polarized light, the characteristics in which light whose wavelength is equal to or longer than a first wavelength that is longer than that (wavelength of blue light) of light source 1a is transmitted and in which light whose wavelength is shorter than the first wavelength is reflected. In addition, dichroic mirror 1h has, with respect to light that is made incident as the P-polarized light, the characteristics in which light whose wavelength is equal to or longer than a second wavelength that is shorter than that (wavelength of blue light) of light source 1a is transmitted and in which light whose wavelength is shorter than the second wavelength is reflected. Dichroic mirror 1h having such characteristics can be realized by a dielectric multilayer film.

Dichroic mirror 1h guides the blue light (S-polarized light) from polarized light separating element if to phosphor unit 1l. ¼ wavelength plate 1j and lenses 1i and 1k are arranged on an optical path between dichroic mirror 1h and phosphor unit 1l.

Phosphor unit 1l includes a phosphor wheel and a driving unit (motor) for rotating the phosphor wheel. In the phosphor wheel, a phosphor region in which, a phosphor that is excited by excitation light to emit fluorescent light is provided and a reflection region are sequentially arranged in a circumferential direction.

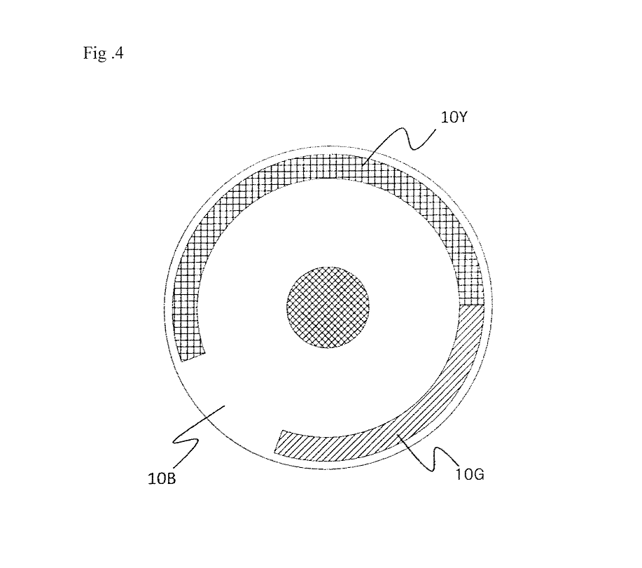

FIG. 4 illustrates an example of the phosphor wheel. Referring to FIG. 4, the phosphor wheel has yellow phosphor region 10Y, green phosphor region 10G, and reflection region 10B. Yellow phosphor region 10Y, green phosphor region 10G, and reflection region 10B are formed so as to be arrayed in the circumferential direction.

Reflection region 10B reflects the blue light from light source 1a. Yellow phosphor region 10Y includes a phosphor that is excited by the excitation light to emit yellow fluorescent light. Green phosphor region 10G includes a phosphor that is excited by the excitation light to emit green fluorescent light. The yellow phosphor and the green phosphor can both be excited by the blue light from light source 1a. Note that the yellow fluorescent light includes the light of a wavelength range from green to red.

The area ratio of each of yellow phosphor region 10Y, green phosphor region 10G, and reflection region 10B in the circumferential direction (division ratio in circumferential direction) is appropriately set according to the balance of the light intensity of each of yellow light, red light, green light and the blue light included in the output light from light source device 1.

¼ wavelength plate 1j is made of a highly light-resistant inorganic material. For example, ¼ wavelength plate 1j has a birefringent multilayer film made of an inorganic material (dielectric substance). The birefringent multilayer film is configured to provide a phase difference of π/2 (=¼λ) to the polarization surface of the incident light. For example, a birefringent layer having an oblique columnar structure formed by depositing particles on a substrate surface from an oblique direction is known to have birefringence for a light beam vertically made incident on the substrate surface. In such a birefringent layer, an arbitrary phase difference can be provided to the polarization surface of the incident light by adjusting a film thickness. In this embodiment, similarly, ¼ wavelength plate 1j is formed by the birefringent multilayer film to which such an oblique columnar structure is applied. The angle dependence of ¼ wavelength inorganic plate 1j is smaller than that of the ¼ wavelength crystal plate. For example, ¼ wavelength inorganic plate 1j can provide a phase difference to light having an incident angle of 40° or less. In addition, ¼ wavelength inorganic plate 1j can be formed thinner than the ¼ wavelength crystal plate and, for example, ¼ wavelength inorganic plate 1j having a thickness of 0.3 mm can be provided.

¼ wavelength plate 1j is disposed between lenses 1i and 1k. Lenses 1i and 1k constitute a condensing lens group for converging the blue light from dichroic mirror 1h on the phosphor wheel of phosphor unit 1l. According to the embodiment, two lenses 1i and 1k constitute the condensing lens group. However, this configuration is in no way limitative. Three or more lenses may constitute the condensing lens group. In such a case, ¼ wavelength plate 1j is disposed between given lenses in the condensing lens group. However, this case must satisfy a condition that between the lenses where ¼ wavelength plate 1j is disposed, the incident angle of the blue light to ¼ wavelength plate 1j is set to an angle not providing any influence of the angle dependence of ¼ wavelength plate 1j. In order to surely satisfy this condition, ¼ wavelength plate 1j may be disposed between, among the plurality of lenses, a first lens located closest to dichroic mirror 1h side and a second lens adjacent to the first lens.

The blue light (S-polarized light) from dichroic mirror 1h passes through ¼ wavelength plate 1j to be converted into circular polarized light. The blue light (circular polarized light) that passed through ¼ wavelength plate 1j is radiated onto the phosphor wheel via lens 1k.

When the phosphor wheel is rotated, the blue light (circular polarized light) from lens 1k is sequentially radiated to yellow phosphor region 10Y, green phosphor region 10G, and reflection region 10B. In yellow phosphor region 10Y, the yellow phosphor excited by the blue light emits yellow fluorescent light. In green phosphor region 10G, the green phosphor excited by the blue light emits green fluorescent light. In reflection region 10B, the blue light from lens 1k is reflected toward lens 1k.

The yellow fluorescent light (unpolarized light) from yellow phosphor region 10Y, the green fluorescent light (unpolarized light) from green phosphor region 10G, and the blue light (circular polarized light) from reflection region 10B respectively pass through lens 1k, ¼ wavelength plate 1j, and lens 1i sequentially to enter dichroic mirror 1h. Here, the blue light (circular polarized light) from reflection region 10B passes through ¼ wavelength plate 1j to be converted into P-polarized light. This blue light (P-polarized light) enters dichroic mirror 1h.

The yellow fluorescent light (unpolarized light), the green fluorescent light (unpolarized light), and the blue light (P-polarized light) from lens 1i pass through dichroic mirror 1h. The yellow fluorescent light, the green fluorescent light, and the blue light that passed through dichroic mirror 1h are converged on the surface of one end of an optical element not illustrated (e.g., light uniformalizing element such as light tunnel or rod integrator) by lens 1m.

Color filter unit 1n includes a color wheel. This color wheel is disposed closer to lens 1m side than the focal position of lens 1m.

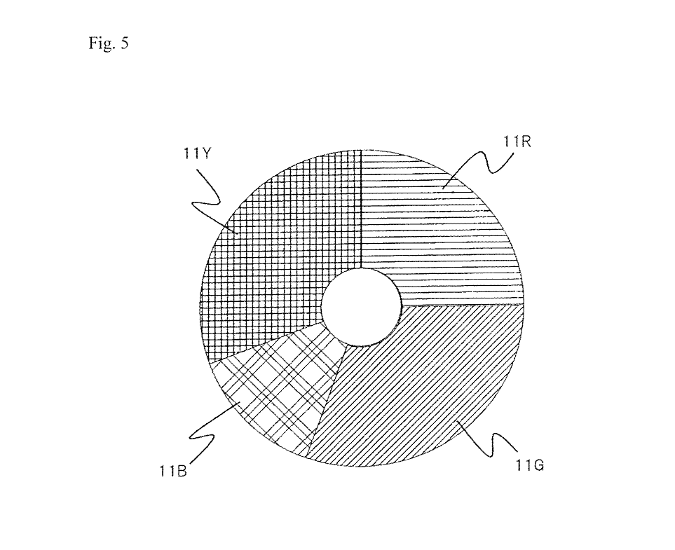

FIG. 5 illustrates an example of the color wheel. Referring to FIG. 5, the color wheel has yellow transmission filter 11Y, red transmission filter 11R, green transmission filter 11G, and diffusion plate 11B. Yellow transmission filter 11Y, red transmission filter 11R, green transmission filter 11G, and diffusion plate 11B are formed so as to be arrayed in the circumferential direction.

The regions of yellow transmission filter 11Y and red transmission filter 11R correspond to yellow phosphor region 10Y of the phosphor wheel illustrated in FIG. 4, and green transmission filter 11G and diffusion plate 11B respectively correspond to green phosphor region 10G and reflection region 10B of the phosphor wheel illustrated in FIG. 4. The area ratios of yellow transmission filter 11Y, red transmission filter 11R, green transmission filter 11G, and diffusion plate 11B in the circumferential direction are similar to those of the respective corresponding regions of the phosphor wheel illustrated in FIG. 4.

The area ratios of yellow transmission filter 11Y and red transmission filter 11R in the circumferential direction are appropriately set according to the balance of the light intensity of each of the yellow light, the red light, the green light and the blue light included in the output light from light source device 1.

Color filter unit 1n and phosphor unit 1l are configured to rotate in synchronization with each other. The yellow fluorescent light from yellow phosphor region 110Y includes the light of a yellow component and the light of a red component, the light of the yellow component is transmitted through yellow transmission filter 11Y, and the light of the red component is transmitted through red transmission filter 11R.

The green fluorescent light from green phosphor region 10G is transmitted through green transmission filter 11G. The blue light from reflection region 10B passes through diffusion plate 11B. The diffusion light of the blue light is emitted from diffusion plate 11B. A diffusion angle, which is, for example, about 10°, can be appropriately changed as needed.

The yellow light, the red light, the green light, and the blue light that passed through color filter unit 1n are output light from light source device 1.

According to the light source device of the embodiment, by disposing ¼ wavelength inorganic plate 1j having angle dependence smaller than that of the ¼ wavelength crystal plate between lens 1i and 1k, miniaturization and the low cost of an optical system can be achieved. Hereinafter, the reason thereof will specifically be described.

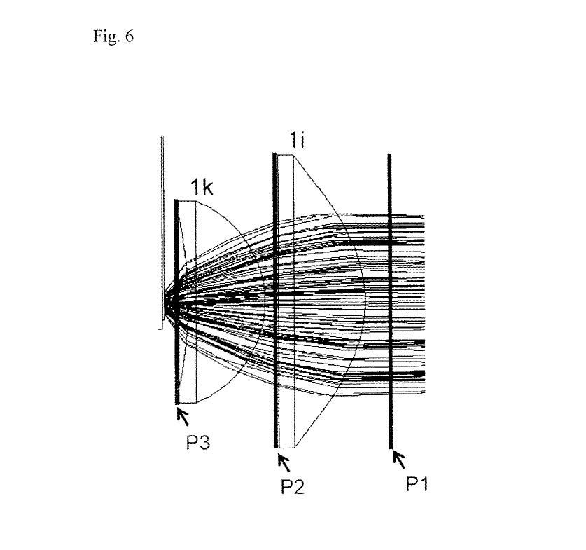

FIG. 6 is a schematic diagram illustrating the relationship between the disposing position of the ¼ wavelength plate and an incident region. When ¼ wavelength plate 1j is disposed at position P1 of dichroic mirror 1h side of lens 1i, the size of a region of ¼ wavelength plate 1j through which the blue light passes is 32 mm square. When ¼ wavelength plate 1j is disposed at position P2 of lens 1k side of lens 1i, the size of a region of ¼ wavelength plate 1j through which the blue light passes is 25 mm square. When ¼ wavelength plate 1j is disposed at position P3 of the phosphor wheel side of lens 1k, the size of a region of ¼ wavelength plate 1j through which the blue light passes is 20 mm square. Thus, the size of the region through which the blue light at the wavelength plate passed at position P3 is smallest, and the size of the region through which the blue light of the wavelength plate passed at position P2 is next smallest.

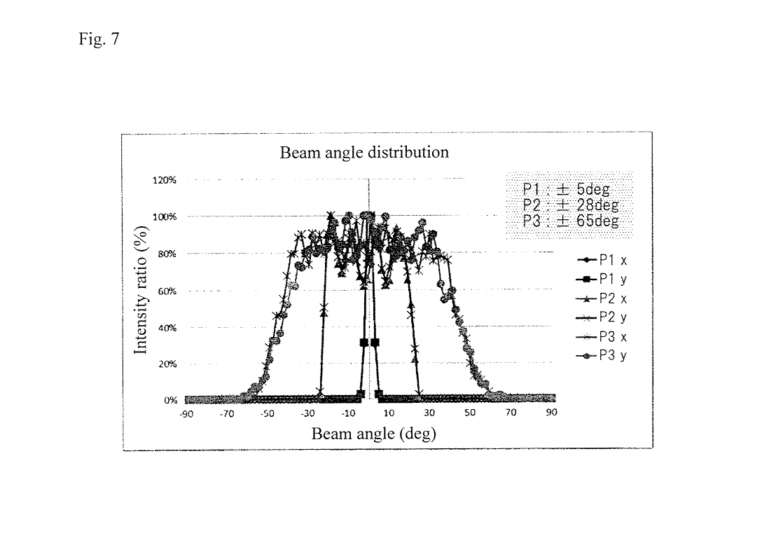

FIG. 7 illustrates a beam angle distribution at each position illustrated in FIG. 6. A vertical axis indicates an intensity ratio (%), and a horizontal axis indicates a beam angle (deg). A solid line connecting black rhombic marks indicates a beam angle distribution in an X direction at position P1. A solid line connecting black square marks indicates a beam angle distribution in a Y direction at position P1. A solid line connecting black triangle marks indicates a beam angle distribution in the X direction at position P2. A solid line connecting X marks indicates a beam angle distribution in the Y direction at position P2. A solid line connecting * marks indicates a beam angle distribution in the X direction at position P3. A solid line connecting circle marks indicates a beam angle distribution in the Y direction at position P3.

The beam angle of the blue light at position P1 is ±5°. The beam angle of the blue light at position P2 is ±28°. The beam angle of the blue light at position P3 is ±65°. Since ¼ wavelength inorganic plate 1j can maintain characteristics for the light of an incident angle of 40° or less, there is no influence of the angle dependence of ¼ wavelength inorganic plate 1j even when it is disposed at position P2. However, when ¼ wavelength plate 1j is disposed at position P3, there is an influence of the angle dependence.

Compared with the configuration where ¼ wavelength plate 1j is disposed at position P1, according to the configuration where ¼ wavelength plate 1j is disposed at position P2, the passing region of the blue light is reduced from 32 mm square to 25 mm square, and thus the size of ¼ wavelength plate 1j can be reduced to achieve low cost.

In addition, according to the configuration where ¼ wavelength plate 1j is disposed at position P2, the optical system including a system for converging fluorescent light can be reduced in size and cost. Hereinafter, the reason thereof will specifically be described.

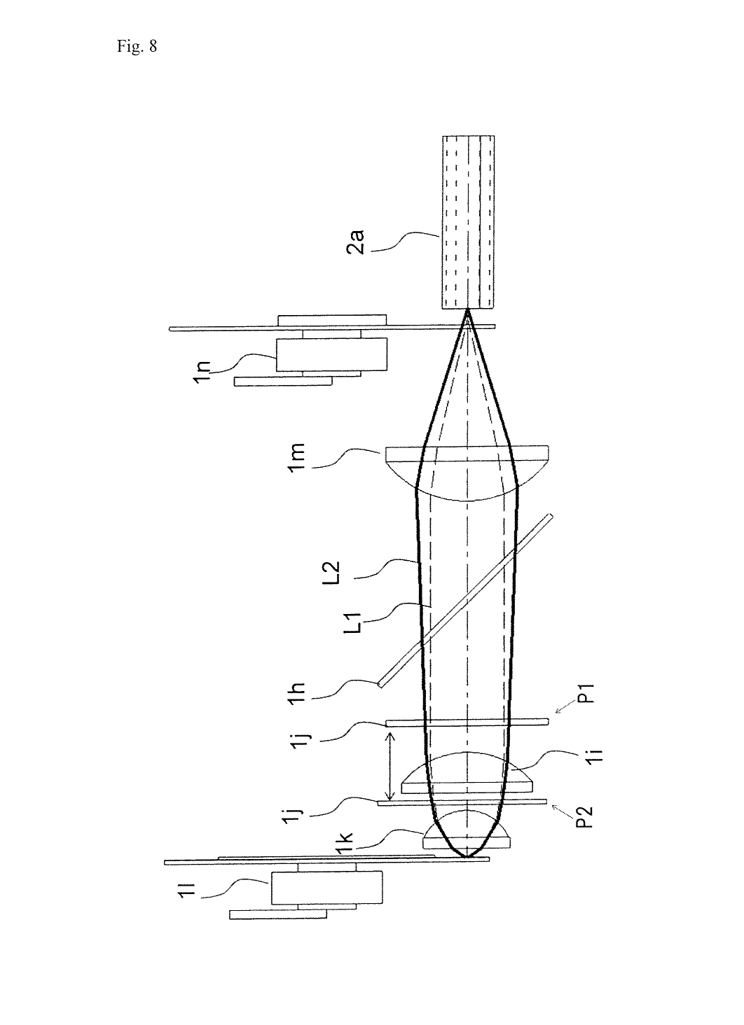

FIG. 8 schematically illustrates the optical paths of the blue light and the fluorescent light. A broken line indicates the reflection optical path of the blue light from reflection region 10B, and a solid line indicates the optical path of the yellow fluorescent light from yellow phosphor region 10Y or the green fluorescent light from green phosphor region 10G.

Lenses 1i and 1k are designed to converge the blue light from dichroic mirror 1h on the irradiation surface of the phosphor wheel, but not to converge the fluorescent light (complete diffusion light) from yellow phosphor region 10Y or green phosphor region 10G. Thus, while the blue light from reflection region 10B is converged by lenses 1i and 1k to be converted into roughly parallel light flux L1, and is transmitted through dichroic mirror 1h, the fluorescent light (complete diffusion light) from yellow phosphor region 10Y or green phosphor region 10G is converged by lenses 1i and 1k, but is transmitted as diffusion light flux L2 through dichroic mirror 1h. In other words, up to lens 1m from the phosphor wheel, the fluorescent light from yellow phosphor region 10Y or green phosphor region 10G propagates as diffusion light flux L2. In this case, since the light flux diameter of diffusion light flux L2 is larger as a distance from the phosphor wheel is longer, when the distance from the phosphor wheel to lens 1m increases, the size of lens 1m must be increased, thus causing an increase in size and cost of the optical system.

In addition, when the distance from the phosphor wheel to lens 1m increases, the distance between lens 1m and light tunnel 2a also increases, thus enlarging the optical system.

For the aforementioned reason, it is desired that the distance from the phosphor wheel to lens 1m be as short as possible.

According to the embodiment, by disposing ¼ wavelength inorganic plate 1j at position P2, the aforementioned problem of the increase in size and cost of the optical system can be solved.

Specifically, lenses 1i and 1k are plano-convex lenses, and convex surfaces are directed toward dichroic mirror 1h side. Dichroic mirror 1h is disposed so that an angle formed with the optical axis of lenses 1i and 1k can be smaller than 45°. In this case, by disposing the end of dichroic mirror 1h located on lens 1i side close to the outer peripheral part of lens 1i, the distance between dichroic mirror 1h and lens 1i can be shortened.

Further, ¼ wavelength plate 1j can be stuck to lens 1i, or directly formed in lens 1i and, as no holder for holding ¼ wavelength plate 1j is necessary, the space between lenses 1i and 1k increases by an amount equal to the thickness of ¼ wavelength plate 1j. ¼ wavelength inorganic plate 1j can be thinned 0.3 mm or less, and thus the increase in space between lenses 1i and 1k is limited.

On the other hand, in the configuration where ¼ wavelength plate 1j is disposed at position P1, ¼ wavelength plate 1j and the convex surface of lend 1i must be arranged not to buffer each other, and ¼ wavelength plate 1j and the end of dichroic mirror 1h must be arranged not to buffer each other. In addition, since ¼ wavelength plate 1j must be held by a holder, the space between dichroic mirror 1h and ¼ wavelength plate 1j and the space between lens 1i and ¼ wavelength plate 1j must be set so as to prevent buffering between the holder of ¼ wavelength plate 1j and the holders of lens 1i and dichroic mirror 1h. As a result, the space between lens 1i and dichroic mirror 1h is much larger than that in the configuration where ¼ wavelength plate 1j is disposed at position P2.

As described above, according to the configuration where ¼ wavelength plate 1j is disposed at position P2, the space between lens 1i and dichroic mirror 1h can be reduced, and thus the distance from the phosphor wheel to lens 1m can be shortened, and the optical system can be reduced in size and cost.

The light source device according to the embodiment can provide the following effects in addition to those described above.

A wavelength region in which the S-polarized light and the P-polarized light can be separated is widened by disposing dichroic mirror 1h so that incident angle θ of the central beam of the blue light from reflection region 10B can be larger than 45°. For example, dichroic mirror 1h is disposed so that incident angle θ of the blue light can be 55°. Thus, the influence of a variation in LD light emission wavelength caused by an individual difference or temperature dependence is reduced.

However, the transmittance of dichroic mirror 1h decreases according to the increase of the incident angle. Accordingly, a part of the blue light (P-polarized light) from reflection region 10B is reflected by dichroic mirror 1h. When the blue light (P-polarized light) reflected by dichroic mirror 1h returns to light source 1a, the LD oscillation operation becomes unstable, and as a result, the output of the LD is reduced. In particular, when there is an image forming relationship between reflection region 10B and light source 1a (light emission point of LD), the blue light from reflection region 10B returns to the light emission point of light source 1a, thus making the problem of the output reduction of the LD more conspicuous.

According to the embodiment, in order to eliminate the blue light returning from dichroic mirror 1h to light source 1a side, polarized light separating element if is disposed on the optical path between dichroic mirror 1h and light source 1a. The blue light (P-polarized light) reflected by dichroic mirror 1h is transmitted through polarized light separating element 1f. The blue light (Po-polarized light) transmitted through polarized light separating element 1f travels in a direction different from the direction of light source 1a, not returning to the light emission point of light source 1a. As a result, the LD oscillation operation does not become unstable.

(Projector)

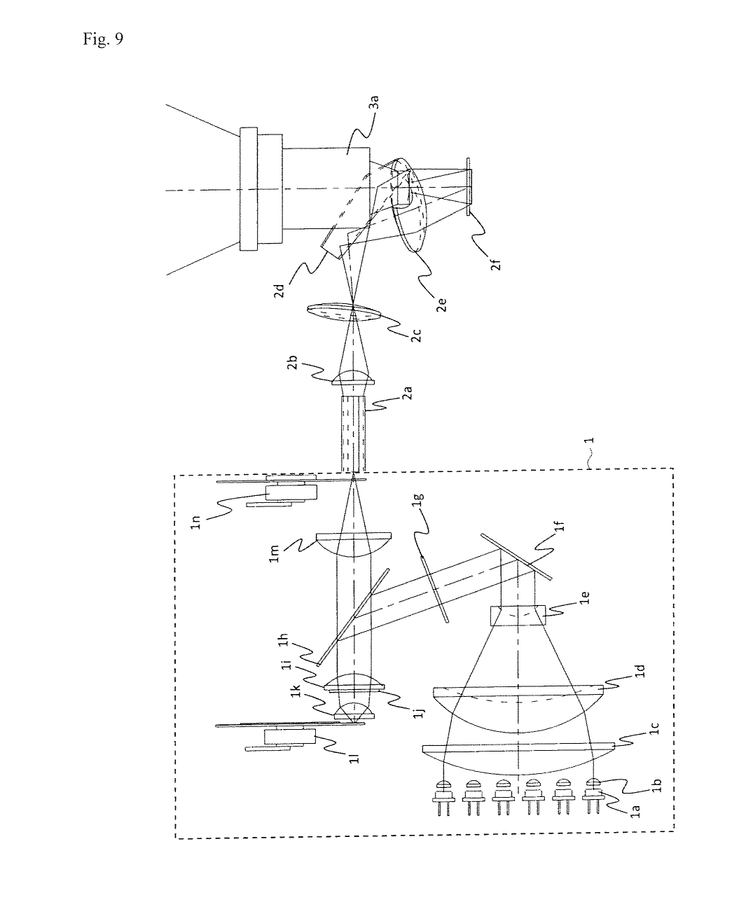

FIG. 9 illustrates the configuration of a projector including light source device 1 illustrated in FIG. 3.

Referring to FIG. 9, the projector includes light source device 1, illumination optical system 2, projection optical system 3, and display element 4.

Illumination optical system 2 guides the output light of light source device 1 to display element 4, and supplies rectangular and uniform light to display element 4. Illumination optical system 2 includes light tunnel 2a, lenses 2b, 2c, and 2e, and mirror 2d.

Light tunnel 2a has a cuboid shape, the output light of light source device 1 enters the inside from one end, and the incident light propagates through the inside to exit from the other end. The surface (incident surface) of one end of light tunnel 2a is disposed at the focal position of lens 1m of light source device 1 illustrated in FIG. 3. There is an image forming relationship between the irradiation surface of the phosphor wheel of phosphor unit 1l and the incident surface of light tunnel 2a.

The light output from the other end of light tunnel 2a is radiated to display element 4 via lenses 2b and 2c, mirror 2d, and lens 2e. Lenses 2b, 2c, and 2e are condensing lenses.

Display element 4 spatially modulates a light flux from illumination optical system 2 according to a video signal to form an image. Display element 4 is, for example, a digital micromirror device (DMD). The DMD has a plurality of micromirrors, each micromirror is configured to change an angle according to a driving voltage, and reflection angles are different between when a driving voltage indicating an ON-state is supplied and when a driving voltage indicating an OFF-state is supplied. By subjecting each micromirror to ON-OFF control according to the video signal, the incident light flux is spatially modulated to form an image. Note that a liquid crystal panel or the like can be used for display element 4 in addition to the DMD.

Projection optical system 3 magnifies and projects the image formed by display element 4 on a projection surface. Any projection surface such as a screen or a wall can be used as long as the image can be projected thereon.

### Second Exemplary Embodiment

A light source device according to the second exemplary embodiment of the present invention will be described.

The light source device according to this embodiment is configured in a manner in which the relationship between the S-polarized light and the P-polarized light in light source device 1 illustrated in FIG. 3 is reversed. Specifically, the arrangement of polarized light separating element 1f, diffusion plate 1g, dichroic mirror 1h, lens 1m, and color filter unit 1n illustrated in FIG. 3 is maintained. Light source 1a, collimator lens 1b, and lenses 1c to 1e are arranged opposite to diffusion plate 1g side of polarized light separating element 1f. ¼ wavelength plate 1j, lenses 1i and 1k, and phosphor unit 1l are arranged opposite to polarized light separating element if side of dichroic mirror 1h.

Polarized light separating element if has the characteristics of reflecting S-polarized light and transmitting P-polarized light. Light source 1a is disposed so that its output light can enter polarized light separating element 1f as P-polarized light.

Blue light (P-polarized light) from light source 1a enters polarized light separating element 1f via collimator lens 1b and lenses 1c to 1e. The blue light (Polarized light) is transmitted through polarized light separating element 1f to enter dichroic mirror 1h via diffusion plate 1g.

Dichroic mirror 1h has, with respect to light that is made incident as P-polarized light, the first characteristics in which light whose wavelength is equal to or shorter than a first wavelength that is longer than that of the blue light is transmitted and in which light whose wavelength is longer than the first wavelength is reflected. In addition, dichroic mirror 1h has, with respect to light that is made incident as S-polarized light, the second characteristics in which light whose wavelength is equal to or shorter than a second wavelength that is shorter than that of the blue light is transmitted and in which light whose wavelength is longer than the second wavelength is reflected. Here, the first wavelength is a cutoff wavelength in the first characteristics, and the second wavelength is a cutoff wavelength in the second characteristics. Dichroic mirror 1h having such characteristics can be realized by a dielectric multilayer film.

The blue light (P-polarized light) from polarized light separating element 1f is transmitted through dichroic mirror 1h to be radiated to phosphor unit 1l via lenses 1i and 1k and ¼ wavelength plate 1j. The blue light (P-polarized light) passes through ¼ wavelength plate 1j to be converted into circular polarized light. The blue light (circular polarized light) is sequentially radiated to yellow phosphor region 10Y, green phosphor region 10G, and reflection region 10B.

In yellow phosphor region 10Y, a yellow phosphor excited by the blue light emits yellow fluorescent light. In green phosphor region 10G, a green phosphor excited by the blue light emits green fluorescent light. In reflection region 10B, the blue light from lens 1k is reflected toward lens 1k.

The yellow fluorescent light (unpolarized light) from yellow phosphor region 10Y, the green fluorescent light (unpolarized light) from green phosphor region 10G, and the blue light (circular polarized light) from reflection region 10B respectively pass through lens 1k, ¼ wavelength plate 1j, and lens 1i sequentially to enter dichroic mirror 1h. Here, the blue light (circular polarized light) from reflection region 10B passes through ¼ wavelength plate 1j to be converted into S-polarized light. This blue light (S-polarized light) enters dichroic mirror 1h.

The yellow fluorescent light (unpolarized light), the green fluorescent light (unpolarized light) and the blue light (P-polarized light) that passed through ¼ wavelength plate 1j are reflected by dichroic mirror 1h. The yellow fluorescent light, the green fluorescent light, and the blue light reflected by dichroic mirror 1h enter the color wheel of color filter unit 1n via lens 1m.

According to the embodiment, as in the case of the first exemplary embodiment, ¼ wavelength plate 1j is made of an inorganic material, and disposed between lens 1i and lens 1k. Thus, the same operation effect as that of the first exemplary embodiment is provided.

In this embodiment, the modifications described in the first exemplary embodiment can be applied. In addition, the light source device of the embodiment can be applied to the projector illustrated in FIG. 9. Specifically, in the projector illustrated in FIG. 9, light source device 1 is replaced with the light source device of this embodiment.

### Third Exemplary Embodiment

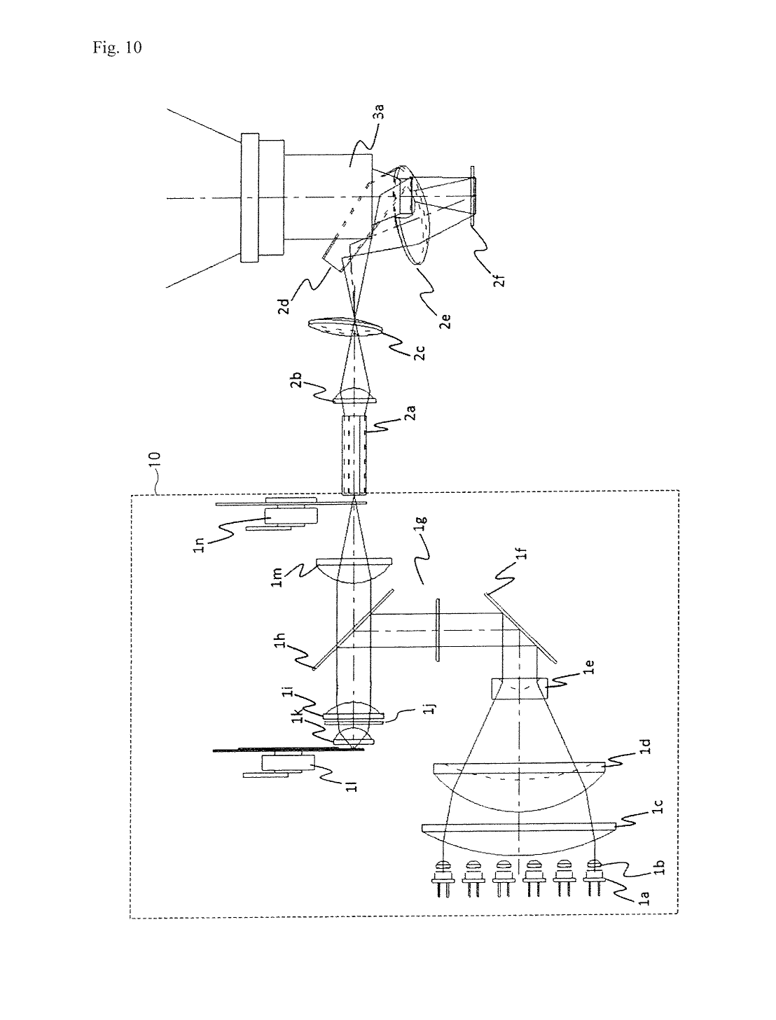

FIG. 10 illustrates the configuration of a projector that includes a light source device according to the third exemplary embodiment of the present invention.

Light source device 10 is the light source device according to this embodiment. In light source device 10, polarized light separating element if is disposed so that the incident angle of the central beam of blue light from light source 1a can be 45°, and dichroic mirror 1h is disposed so that the incident angle of the central beam of blue light from reflection region 10B can be 45°. Other configurations are similar to those of the light source device of the first exemplary embodiment.

¼ wavelength plate 1j is similar to that described in the first exemplary embodiment. In this embodiment, similarly, ¼ wavelength plate 1j is disposed between lens 1i and lens 1k. Accordingly, the same operation effect as that of the first exemplary embodiment can be provided.

When three or more lenses constitute a condensing lens group, ¼ wavelength plate 1j is disposed between given lenses in the condensing lens group. However, this case must satisfy a condition in which between the lenses where ¼ wavelength plate 1j is disposed, the incident angle of the blue light to ¼ wavelength plate 1j is set at an angle such the angle dependence of ¼ wavelength plate 1j does not have any influence.

The projector illustrated in FIG. 10 includes light source device 10, illumination optical system 2, projection optical system 3, and display element 4. Illumination optical system 2, projection optical system 3, and display element 4 are similar to those of the projector described in the first exemplary embodiment. In this projector, an image is magnified and projected by the same operation as that of the projector described in the first exemplary embodiment.

In this embodiment, similarly, the modification described in the first exemplary embodiment can be applied.

### Fourth Exemplary Embodiment

A light source device according to the fourth exemplary embodiment of the present invention will be described.

The light source device according to this embodiment is configured in a manner in which the relationship between S-polarized light and P-polarized light in light source device 10 illustrated in FIG. 10 is reversed. Specifically, the arrangement of polarized light separating element 1f, diffusion plate 1g, dichroic mirror 1h, lens 1m, and color filter unit 1n illustrated in FIG. 10 is maintained. Light source 1a, collimator lens 1b, and lenses 1c to 1e are arranged opposite to diffusion plate 1g side of polarized light separating element 1f. ¼ wavelength plate 1j, lenses 1i and 1k, and phosphor unit 1l are arranged opposite to polarized light separating element if side of dichroic mirror 1h.

The operation of the light source device according to this embodiment is similar to that of the light source device of the second exemplary embodiment. In addition, in a projector that includes the light source device of this embodiment, an image is magnified and projected by the same operation as that of the projector that includes the light source device of the second exemplary embodiment.

In this embodiment, similarly, the modification described in the first exemplary embodiment can be applied.

The light source device and the projector according to the respective embodiments described above are only examples of the present invention, and the configurations and the operations thereof can be changed as occasion demands.

For example, in the first exemplary embodiment, color filter unit 1n may be omitted, a diffusion layer may be provided on reflection region 10B in the phosphor wheel of phosphor unit 1l illustrated in FIG. 4, and a part or all of yellow phosphor region 10Y may be replaced with a red phosphor region. This modification can also be applied to the second to fourth exemplary embodiments.

In the first exemplary embodiment, light source device 1 may include a part or all of illumination optical system 2. This modification can also be applied to the second to fourth exemplary embodiments.

Further, in each embodiment, the ¼ wavelength inorganic plate may be prepared by forming an inorganic birefringent multilayer film on a substrate made of glass or quartz by a vapor deposition method, or by directly forming the inorganic birefringent multilayer film in the lens by the vapor deposition method.

The present invention can employ configurations described in the following Supplementary Notes. However, the invention is limited to these configurations.

### [Supplementary Note 1]

A light source device comprising:

a light source that emits excitation light;

a dichroic mirror that is configured to reflect or transmit first linearly polarized light of light from the light source;

a first condensing lens group that includes a plurality of lenses and that is configured to converge reflected light or transmitted light from the dichroic mirror;

a phosphor unit that includes a phosphor region in which a phosphor is provided and a reflection region in which incident light is reflected and that is movable so that light from the first condensing lens group can be sequentially radiated to the phosphor region and the reflection region; and

a ¼ wavelength plate that is provided between two adjacent lenses from among the plurality of lenses,

wherein each of the first condensing lens group and the phosphor unit is disposed so that fluorescent light emitted from the phosphor region and reflected light from the reflection region enter the dichroic mirror via the first condensing lens group and the ¼ wavelength plate.

### [Supplementary Note 2]

The light source device according to Supplementary Note 1, wherein the ¼ wavelength plate is disposed between, from among the plurality of lenses, a first lens that is disposed on the dichroic mirror side and a second lens adjacent to the first lens.

### [Supplementary Note 3]

The light source device according to Supplementary Note 1 or 2, wherein the ¼ wavelength plate includes an inorganic birefringent multilayer film that is configured to provide a phase difference of ¼λ to a polarization surface of the incident light, λ denoting a wavelength of the light source.

### [Supplementary Note 4]

The light source device according to any one of Supplementary Notes 1 to 3, further comprising a second condensing lens group that includes a plurality of lenses that converge output light from the light source,

wherein the first and second condensing lens groups form a light source image of the light source on a surface that includes the phosphor region and the reflection region.

### [Supplementary Note 5]

The light source device according to any one of Supplementary Notes 1 to 4, further comprising a condensing lens that is provided so that the fluorescent light emitted from the phosphor region and the reflected light from the reflection region enter the condensing lens via the first condensing lens group, the ¼ wavelength plate and the dichroic mirror, the condensing lens condensing light made incident.

### [Supplementary Note 6]

The light source device according to Supplementary Note 5, further comprising a color filter unit that includes a yellow transmission filter, a red transmission filter, a green transmission filter and a diffusion region, and that is movable so that light from the condensing lens sequentially enter the yellow transmission filter, the red transmission filter, the green transmission filter and the diffusion region, wherein:

the phosphor region includes a yellow phosphor region in which a phosphor that emits yellow fluorescent light is provided, and a green phosphor region in which a phosphor that emits green fluorescent light is provided; and

the yellow fluorescent light from the yellow phosphor region sequentially enters the yellow transmission filter and the red transmission filter, the green fluorescent light from the green phosphor region enters the green transmission filter, and blue light from the reflection region enters the diffusion region.

### [Supplementary Note 7]

A projector comprising:

the light source device according to any one of claims 1 to 6;

a display element that spatially modulates light output from the light source device to form an image; and

a projection optical system that magnifies and projects the image formed by the display element.

1. A light source device comprising:
a light source that emits excitation light;
a dichroic mirror that is configured to reflect or transmit first linearly polarized light of light from the light source;
a first condensing lens group that includes a plurality of lenses and that is configured to converge reflected light or transmitted light from the dichroic mirror;
a phosphor unit that includes a phosphor region in which a phosphor is provided and a reflection region in which incident light is reflected and that is movable so that light from the first condensing lens group can be sequentially radiated to the phosphor region and the reflection region; and
a ¼ wavelength plate that is provided between two adjacent lenses from among the plurality of lenses,
wherein each of the first condensing lens group and the phosphor unit is disposed so that fluorescent light emitted from the phosphor region and reflected light from the reflection region enter the dichroic mirror via the first condensing lens group and the ¼ wavelength plate.

2. The light source device according to claim 1, wherein the ¼ wavelength plate is disposed between, from among the plurality of lenses, a first lens that is disposed on the dichroic mirror side and a second lens adjacent to the first lens.

3. The light source device according to claim 1, wherein the ¼ wavelength plate includes an inorganic birefringent multilayer film that is configured to provide a phase difference of ¼λ to a polarization surface of the incident light, λ denoting a wavelength of the light source.

4. The light source device according to claim 1, further comprising a second condensing lens group that includes a plurality of lenses that converge output light from the light source,
wherein the first and second condensing lens groups form a light source image of the light source on a surface that includes the phosphor region and the reflection region.

5. The light source device according to claim 1, further comprising a condensing lens that is provided so that the fluorescent light emitted from the phosphor region and the reflected light from the reflection region enter the condensing lens via the first condensing lens group, the ¼ wavelength plate and the dichroic mirror, the condensing lens condensing light made incident.

6. The light source device according to claim 5, further comprising a color filter unit that includes a yellow transmission filter, a red transmission filter, a green transmission filter and a diffusion region, and that is movable so that light from the condensing lens sequentially enter the yellow transmission filter, the red transmission filter, the green transmission filter and the diffusion region, wherein:
the phosphor region includes a yellow phosphor region in which a phosphor that emits yellow fluorescent light is provided, and a green phosphor region in which a phosphor that emits green fluorescent light is provided; and
the yellow fluorescent light from the yellow phosphor region sequentially enters the yellow transmission filter and the red transmission filter, the green fluorescent light from the green phosphor region enters the green transmission filter, and blue light from the reflection region enters the diffusion region.

7. A projector comprising:
the light source device according to claim 1;
a display element that spatially modulates light output from the light source device to form an image; and
a projection optical system that magnifies and projects the image formed by the display element.
